(19) United States
(12) Patent Application Publication
(10) Pub. No.: US 2012/0315943 A1
(43) Pub. Date: Dec. 13, 2012

(54) SP/CBP SCHEDULE INFORMATION DISTRIBUTION

(75) Inventors: Liwen Chu, San Ramon, CA (US); George A. Vlantis, Sunnyvale, CA (US)

(73) Assignee: STMicroelectronics, Inc., Coppell, TX (US)

(21) Appl. No.: 13/154,972

(22) Filed: Jun. 7, 2011

(51) Int. Cl. H04W 72/04; H04W 74/00

(52) U.S. Cl. 455/512; 455/509

(57) ABSTRACT

The distribution of the service period (SP) and contention-based period (CBP) scheduling information in the data transfer time (DTT) of a beacon interval (BI) defined under the WGA Draft Specification 0.8 is selectively scheduled to optimize channel access contention. STAs in a single antenna scope or groups of STAs in multiple antennas scopes is allocated to different CBPs to decrease collisions. Simultaneous CBPs is further allocated to STAs in multiple antennas scopes where STAs have peer-to-peer traffic with other STAs in the same antenna group during part of the CBP when the personal PCP/AP is unavailable to that antenna group resulting in an increase in network throughput.

### RELATED APPLICATIONS

The present application relates to co-pending U.S. patent application Ser. No. 13/113,574 and U.S. Provisional Patent Application Ser. No. 61/426,983.

### FIELD OF THE INVENTION

This invention relates to a method of scheduling communications in a wireless network, and more specifically, to a method of selective scheduling of channel access contention in single and multiple antennas scopes.

### BACKGROUND OF THE INVENTION

The Wireless Gigabit Alliance (WGA) Draft Specification 0.8 (WGA-D08), January 2010, herein incorporated by reference, defines modifications to both the 802.11 physical layers (PHY) and the 802.11 Medium Access Control Layer (MAC) to enable operation in the 60 GHz frequency bank (mmWave) for very high throughput wireless networks.

The personal basic service set (PBSS) is a self-contained network which includes one PBSS control point (PCP) and other stations (STAs). Wireless communication is possible to all member STAs of the PBSS. The (infrastructure) BSS is a network which includes a set of STAs that have successfully synchronized using the JOIN service primitives and one STA that has used the START primitive. Membership in a BSS does not imply that wireless communication with all other members of the BSS is possible. An access point (AP) in BSS serves as gateway to access another network, e.g., the Internet.

Section 9.23 of WGA-D08 defines the mmWave channel access. Channel access by a mmWave station (mSTA) during the Beacon Intervals (BI) and is coordinated by a schedule. The schedule of the data transfer time (DTT) of a BI is communicated through the Extended Schedule element in the Announce frame or the mmWave Beacon frame. The Extended Schedule element contains the scheduling information of all allocations in the DTT.

FIG. 1 shows an example of a BI structure. The DTT is an access period during which frame exchanges are performed between STAs. The DTT is comprised of the contention-based access periods (CBPs) and service periods (SPs).

Section 9.23.6 of WGA-D08 defines the time division based channel access in DTT. It is noted that all the time in a DTT will be allocated to SPs and CBPs. There is no longer any unallocated time in a DTT. Thus, if a STA receives schedule information that does not include some DTT time, such DTT time is allocated to other STAs.

### SUMMARY OF THE INVENTION

The present invention is directed to a method of scheduling channel access contention.

In one embodiment of the present invention, groups of stations in a PBSS are scheduled to allocate to different contention periods. The groups of stations comprise subsets of all stations in a PBSS. Therefore, each contention period will have the benefit of decrease collision.

In another embodiment of the present invention, each antenna in the PCP/AP with multiple antennas services a group of stations. These groups of stations are scheduled to allocate to different contention periods. Therefore, each contention period will have further benefit of decrease collision.

In yet another embodiment of the present invention, stations in each group of stations serviced by an antenna in the PCP/AP with multiple antennas are scheduled to have peer-to-peer traffic to other stations within the same group simultaneous in a contention period even when the PCP/AP is not available to that group during that period. Therefore, the PBSS will have the benefit of increased throughput in a contention period.

In another embodiment of the present invention, a non-trucatable service period (SP) scheduling information are sent only to the SP's assigned source and destination.

The foregoing and other features, utilities and advantages of the invention will be apparent from the following more particular description of an embodiment of the invention as illustrated in the accompanying drawings.

In addition, the features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

FIG. 1 shows the BI structure as defined in WGA-D08;

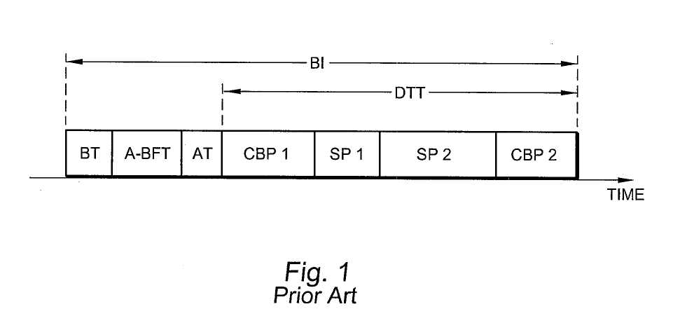

FIG. 2 shows a single antenna PCP/AP BSS according to one embodiment of the invention;

FIG. 3 shows a multiple antennas PCP/AP BSS according to another embodiment of the invention; and

FIG. 4 shows a multiple antennas PCP/AP BSS according to yet another embodiment of the invention.

### DETAILED DESCRIPTION

Embodiments of the present invention are hereafter described in detail with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

The invention relates to a novel method for scheduling contention periods in a wireless network to avoid or decrease collisions during the contention periods and to increase throughput in a BSS. The method has added advantages of saving power for STAs. Further, the announcement/beacon frame for the scheduling is shorter as the present invention reduces the need to transmit all scheduling information to all STAs.

It is observed that not all STAs are required to receive all scheduling information in a DTT. While STAs are allowed to transmit and/or receive during its own SPs and any CBP or any truncatable SP allocated to other STAs, other STAs cannot use the time allocated to an untruncatable SP even if STA it is allocated for is not transmitting.

Accordingly, scheduling information for non-truncatable SPs are sent only to the SP's assigned source and destination STA according to one embodiment of the invention.

Also, STAs thus only need to receive scheduling information for SPs allocated to itself, for CBPs, and for truncatable SPs allocated to other STAs. A PCP/AP only needs to transmit these schedules to those STAs. Further, it is observed that a STA will treat the time in a DTT for which it has no allocation information as being the allocated time for some other STAs.

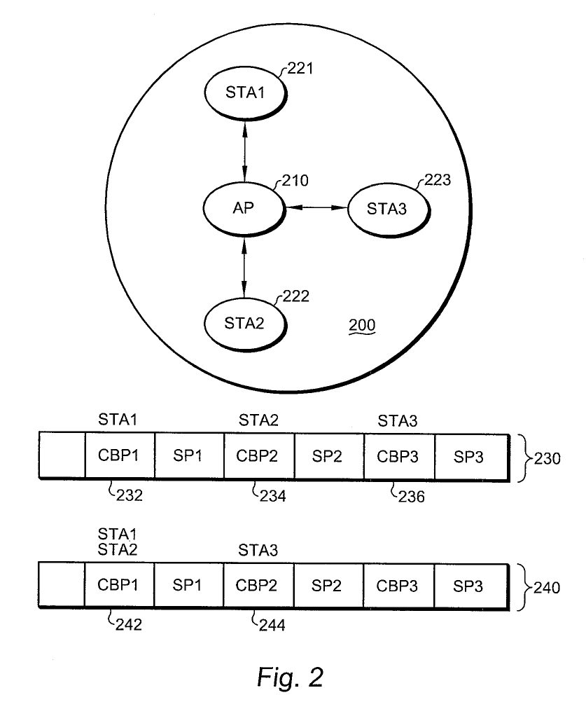

FIG. 2 shows a BSS according to one embodiment of the invention. In PBSS/BSS 200, PCP/AP 210 has one antenna and services many STAs (221, 222, 223) within the same antenna scope. PCP/AP 210 allocates the STAs to different CBPs resulting in decrease collisions.

BI structure 230 shows one possible CBP schedule for PBSS 200. In BI structure 230, CBP1 232 is allocated solely to PCP/AP 210 and STA1 221, CBP2 234 is allocated solely to PCP/AP 210 and STA2 222, and CBP3 236 is allocated solely to PCP/AP 210 and STA3 223. There is no collision in this CBP schedule.

BI structure 240 shows another possible CBP schedule for PBSS/BSS 200. In BI structure 240, CBP1 242 is allocated to both PCP/AP 210, STA1 221 and STA2 222. CBP2 244 is allocated solely to PCP/AP 210 and STA3 223. In this CBP schedule, PCP/AP 210, STA1 221 and STA2 222 may compete for channel access in CBP1 242. However, since STA3 223 is not allocated to CBP1 242, there is less chance of collision than the situation where all associated STAs may compete for channel access in a CBP.

Allocation of each STA to a CBP may be optimally distributed based on the characteristics and usages of each STA.

It is further noted that in mmWave communication, antennas tend to be directional rather than omnidirectional. A common PCP/AP configuration for a BSS is to have multiple antennas servicing STAs in various non-overlapping directional areas. Under WGA-D08, section 9.23.5, the PCP/AP should use only one antenna during each CBP; therefore, not all STAs require all the CBP schedule information.

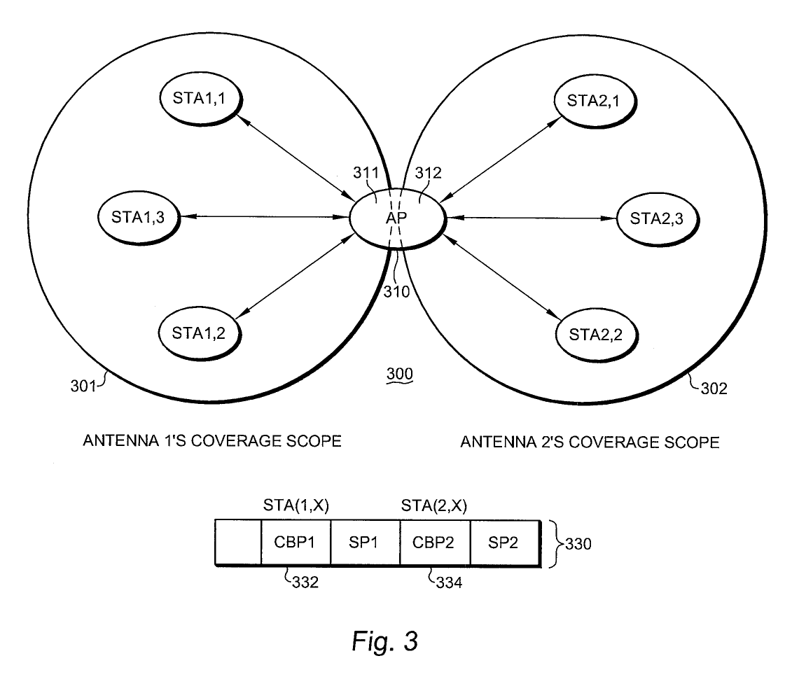

FIG. 3 shows a BSS according to another embodiment of the invention. In a BSS where the PCP/AP has multiple antennas, STAs might only connect to a limited group of antennas that is less than the number of all antennas in the PCP/AP. If the PCP/AP uses only a small group of antennas during each CBP, not all STAs require all the CBP schedules for all STAs. Therefore, STAs can save power since some STAs do not need to be active in some CBPs.

By way of example, PCP/AP 310 in PBSS 300 has two antennas 311 and 312. Non-AP STAs (STA1,x and STA2,x) have one antenna and can also have traffic to/from some outside network, e.g. the Internet. Antenna 311 services STAs (STA1,x) in Group 301, and antenna 312 services STAs (STA2,x) in Group 302. Since STAs in Group 301 communicates with PCP/AP 310 via only 311, STAs in Group 301 do not need to know the CBP that PCP/AP 310 serves to STAs in Group 302 and vice versa.

BI structure 330 shows one possible CBP schedule for PBSS 300. In BI structure 330, CBP1 332 is allocated to PCP/AP 310, STAs in Group 301 (STA1,x) and CBP2 334 is allocated to PCP/AP 310, STAs in Group 302 (STA2,x). Hence, STAs in Group 302 do not need to be active during CBP1 332, and STAs in Group 301 do not need to be active during CBP2 334.

Allocation of each group of STAs to a CBP may be optimally distributed based on the characteristics and usages of each group of STAs.

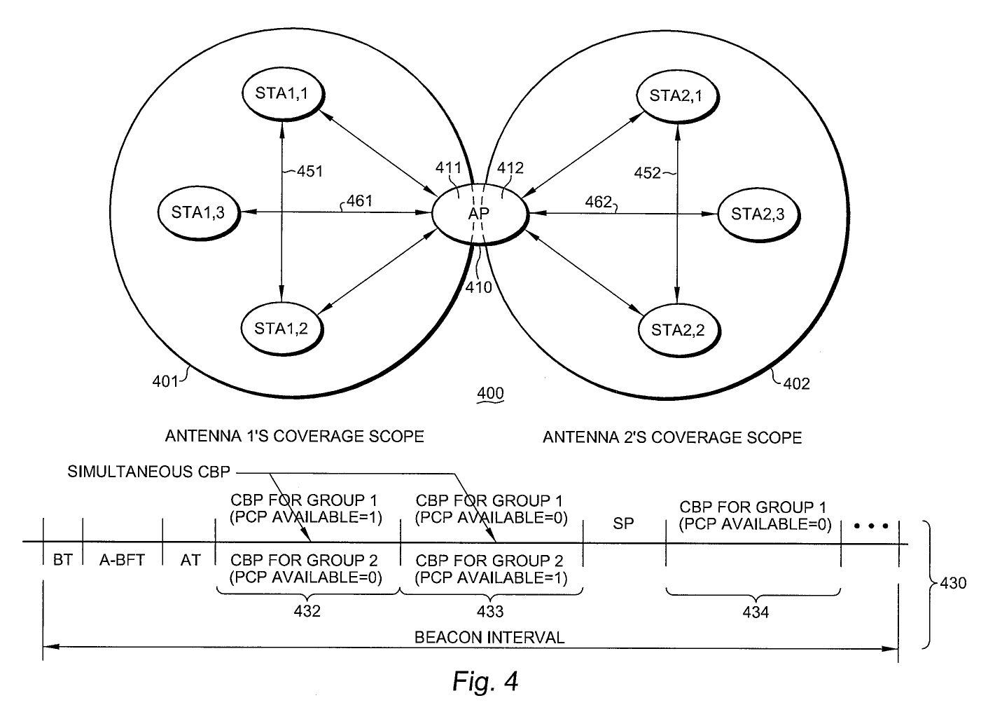

FIG. 4 shows a BSS according to yet another embodiment of the invention. In a BSS where the PCP/AP has multiple antennas, STAs might connect to a limited group of antennas that is less than the number of all antennas in the PCP/AP. WGA-D08 defines that the PCP/AP should use only one antenna during each CBP.

It is noted that peer-to-peer traffic between STAs do not need to go through the PCP/AP. Therefore, peer-to-peer traffic between STAs can be simultaneous during CBP even where the antenna of the PCP/AP servicing the particular STAs are unavailable. Simultaneous CBP can increase the throughput of the BSS.

By the way of example, PCP/AP 410 in PBSS 400 has two antennas: antenna 411 for STAs in Group 401 (STA1,x), antenna 412 for STAs in Group 402 (STA2,x). Non-AP STAs (STA1,x and STA2,x) have one antenna and have traffic to/from outside network, e.g. the Internet and peer-to-peer traffic with each other.

BI structure 430 shows one possible CBP schedule for PBSS 400. In BI structure 430, CBP 432 and CBP 433 are allocated to both Group 401 and Group 402. Antenna 411 is active only during CBP 432, and antenna 412 is active only during CBP 433. When antenna 411 is active, simultaneous CBP schedule information to STAs in Group 401 has PCP available set to 1, and simultaneous CBP schedule information to STAs in Group 402 has PCP available set to 0. Therefore, peer-to-peer traffic among STAs in Group 401, i.e., traffic 451 between STA1,1 and STA1,2, is available during the CBP 432, and traffic to/from AP, i.e., traffic 461 between STA1,3 and AP 410 is also available during CBP 432. However, only peer-to-peer traffic among STAs in Group 402, i.e., traffic 452 between STA2,1 and STA2,2 is available during the CBP 432. Peer-to-peer traffic among STAs in Group 402, i.e., traffic 452 between STA2,1 and STA2,2, is available during the CBP 433 and traffic to/from AP, i.e., traffic 462 between STA2,3 and AP 410 is also available during CBP 433. However, only peer-to-peer traffic among STAs in Group 401, i.e., traffic 451 between STA1,1 and STA1,2 is available during the entire CBP 433. BI schedule 430 can contain other CBP periods, i.e., CBP 434, where PCP/AP 410 is not available to stations in either Group 401 or Group 402.

The length of time to which the PCP/AP is available to each group of STAs may be optimally distributed based on the characteristics and usages of each group of STAs.

In an embodiment, the present invention can be implemented in software as executed by a central processing unit. Software programming code, which can embody the present invention is typically accessed by a microprocessor from long-term, persistent storage media of some type, such as a flash drive or hard drive. The software programming code may be embodied in any of a variety of known media for use with a data processing system, such as a diskette, hard drive, or CD-ROM. The code may be distributed on such media, or may be distributed from the memory or storage of one computer system over a network of some type to other computer systems for use by such other systems. Alternatively, the programming code may be embodied in the memory of the device and accessed by a microprocessor using an internal bus. The techniques and methods for embodying software programming code in memory, on physical media, and/or distributing software code via networks are well known and will not be further discussed herein.

A presently preferred embodiment of the present invention and many of its improvements have been described with a degree of particularity. It should be understood that this description has been made by way of example, and that the invention is defined by the scope of the following claims.

We claim:

1. A method of scheduling communications in a personal basic service set (PBSS) or an infrastructure BSS, comprising:
allocating a first time period in which stations in a first group of stations can compete for channel access; and
allocating a second time period in which stations in a second group of stations can compete for channel access, wherein
the composition of the first group of stations is different from the composition of second group of stations.

2. The method of scheduling communications of claim 1, wherein the PBSS or the infrastructure BSS comprises a mmWave network.

3. The method of scheduling communications of claim 1, wherein the first and second time periods are contention-based periods (CBPs) or truncatable service periods (SPs).

4. The method of scheduling communications of claim 1, wherein the first group of stations comprises at least two stations.

5. The method of scheduling communications of claim 1, wherein the second group of stations comprises at least two stations.

6. The method of scheduling communications of claim 1, further comprising allocating one or more time periods in which stations in one or more groups of stations can compete for channel access, wherein the composition of the groups of stations are different from the composition of the first and second groups of stations and each other groups of stations.

7. A method of scheduling communications in a personal basic service set (PBSS) or an infrastructure BSS, comprising:
allocating a first time period in which stations in a first group of stations connected to a first antenna of a PBSS control point and/or access point (PCP/AP) can compete for channel access; and
allocating a second time period in which stations in a second group of stations connected to a second antenna of the PCP/AP can compete for channel access.

8. The method of scheduling communications of claim 7, wherein the PBSS or the infrastructure BSS comprises a mmWave network.

9. The method of scheduling communications of claim 7, wherein the composition of the first group of stations is different from the composition of the second group of stations.

10. The method of scheduling communications of claim 7, wherein the scope of coverage of the first antenna is distinct from the scope of coverage of the second antenna.

11. The method of scheduling communications of claim 7, wherein stations in the first group connects to the PCP/AP only through the first antenna and stations in the second group connects to the PCP/AP only through the second antenna.

12. The method of scheduling communications of claim 7, wherein the first and second time periods are contention-based periods (CBPs) or truncatable service periods (SPs).

13. The method of scheduling communications of claim 7, further comprising allocating one or more time periods in which stations in one or more groups of stations connected to one or more respective antennas of the PCP/AP can compete for channel access.

14. A method of scheduling communications in a personal basic service set (PBSS) or an infrastructure BSS, comprising:
allocating a first time period in which stations in a first and second group of stations can compete for channel access; and
allocating a second time period in which stations in the first and second group of stations can compete for channel access, wherein
a PBSS control point and/or access point (PCP/AP) servicing stations in the first group through a first antenna is available to stations in the first group only during the first time period; and wherein
the PCP/AP servicing stations in the second group through a second antenna is available to stations in the second group only during the second time period.

15. The method of scheduling communications of claim 14, wherein the PBSS or the infrastructure BSS comprises a mmWave network.

16. The method of scheduling communications of claim 14, further comprising allocating a third time period in which stations in the first and second group of stations can compete for channel access; wherein the PCP/AP is not available to either the first or second groups.

17. The method of scheduling communications of claim 14, wherein the composition of the first group of stations is different from the composition of the second group of stations.

18. The method of scheduling communications of claim 14, wherein the scope of coverage of the first antenna is distinct from the scope of coverage of the second antenna.

19. The method of scheduling communications of claim 14, wherein stations in the first group connects to the PCP/AP only through the first antenna and the stations in the second group connects to the PCP/AP only through the second antenna.

20. The method of scheduling communications of claim 14, wherein a first station in the first group have peer-to-peer traffic with a second station in the first group.

21. The method of scheduling communications of claim 14, wherein a first station in the second group have peer-to-peer traffic with a second station in the second group.

22. The method of scheduling communications of claim 14, wherein the first and second time periods make up a contention-based period (CBP) or truncatable service periods (SPs).

23. The method of scheduling communications of claim 14, further comprising allocating one or more time periods in which stations in the first, the second, and one or more groups of stations can compete for channel access, wherein the PCP servicing stations in each of the groups of stations through a respective antenna is available to stations in the respective group only during a respective time period of the one or more time periods.

24. A method of scheduling communications in a personal base service set (PBSS) or an infrastructure BSS comprising sending a non-trucatable service period (SP) scheduling information only to the SP's assigned source and destination.
